(19) United States
(12) Patent Application Publication
(10) Pub. No.: US 2016/0314488 A1
(43) Pub. Date: Oct. 27, 2016

(54) Method and System for Reinforcing Good Behavior

(71) Applicants: Philip L. Lieberman, Evansville, IN (US); Patrick L. Heck, Evansville, IN (US)

(72) Inventors: Philip L. Lieberman, Evansville, IN (US); Patrick L. Heck, Evansville, IN (US)

(21) Appl. No.: 15/079,809

(22) Filed: Mar. 24, 2016

Related U.S. Application Data
(60) Provisional application No. 62/140,502, filed on Mar. 31, 2015.

(51) Int. Cl. G06Q 30/02

(52) U.S. Cl. CPC G06Q 30/0231; G06Q 30/0233

(57) ABSTRACT

An automated process for motivating persons to exhibit good, desirable behaviors at home, in the school and in other facilities. When a person has demonstrated good behavior and a user has elected to reward that person for the good behavior, the user accesses the reward-based system and enters the value or number of points earned by the person for the good behavior. The user then identifies the person to be rewarded by entering the person's unique ID number. The system accumulates or adds the number of points entered to that person's totaled earned points value and the person's total earned points value is saved in the system. The person may redeem the person's accumulated earn points by selecting a particular reward to redeem and the “cost” of the reward is immediately deducted from the person's total earned points value balance.

### CROSS REFERENCES TO RELATED APPLICATIONS

U.S. Provisional Application for Patent No. 62/140,502, filed Mar. 31, 2015, with title “Method for Teaching and Reinforcing Good Behavior” which is hereby incorporated by reference. Applicant claims priority pursuant to 35 U.S.C. Par. 119(e)(i).

Statement as to rights to inventions made under federally sponsored research and development

Not Applicable.

### BACKGROUND OF THE INVENTION

1. Field of the Invention

The present invention relates generally to a computer implemented reinforcing method, and more particularly, to a system and method for rewarding a person for good behavior. The present invention discloses an automated process for tracking behaviors, earning points and rewards.

2. Brief Description of Prior Art

Motivating a person to exhibit good behavior is a challenge faced by every parent, teacher, administrator, and supervisor that deals with various personnel and persons including, but not limited to, correctional facilities. It is often common to resort to punishment for bad behavior as a means for motivating good behavior. However, for example with children, child development specialists generally agree that negative rewards for bad behavior are not as effective as positive rewards for good behavior.

While multiple methods exist for tracking activities and behaviors, both manual and automated, the prior art lacks a number of valuable components for tracking and the implementation of rewarding for good behavior.

The present invention provides a means for motivating a person to exhibit good behavior and to reward the person for consistent good behavior.

### SUMMARY OF THE INVENTION

In an exemplary embodiment, the present invention is directed to an automated process for motivating persons to exhibit good, desirable behaviors at home, in the school and in other facilities.

In one embodiment, the automated process includes an administrator's device that is a smartphone or other mobile handheld wireless computerized communications device having standard smartphone functionality, including WiFi transceivers, and may be implemented in the form of a standard smartphone app.

In application, when a person has demonstrated good behavior and an administrator has elected to reward that person for the good behavior, the administrator first logs into or accesses the reward-based system by entering the administrator's unique identifier and password (if required) on the administrator's device. The administrator then selects and enters the value or number of points earned by the person for the good behavior, and then identifies the person or persons to be rewarded by entering the person's unique ID number. Once the person's ID number has been entered and the system acknowledges recognition that it has found the person in the system, the system accumulates or adds the number of points entered to that person's total earned points value. Finally, when all information is correct, the person's total earned points value is saved in the system.

The system allows access to a person's total earned points value. However, access to a person's earned points value requires knowing that person's identifying information such as username, password, and/or ID number.

The reward component allows a person to accumulate earned rewards and manage the earned rewards. The person can choose to view his/her rewards from a user interface provided by the reward-based system. When redeeming, the person has a choice of what type of reward is made from a variety of reward types. Each available reward has a cost or value associated, i.e. the total number of points needed to purchase the reward. When a person selects a reward, the appropriate redemption process occurs, including deducting the number of points needed to purchase the reward from the person's total earned points value and saving the person's new total earned points value balance system. As such, when the person chooses a particular reward to redeem, the “cost” of the reward is immediately deducted from the person's total earned points value balance, and the selected reward may be immediately tendered to the person.

The foregoing and other aspects, advantages and objects of the present invention may be more fully appreciated by reference to the following detailed description.

### BRIEF DESCRIPTION OF THE DRAWINGS

FIG. 1 is a block diagram of an example embodiment of a figure upon which embodiment's inventive subject matter can execute.

FIG. 2 is a flowchart of one particular method for configuring administrative and non-administrative accounts in accordance with using reinforcing good behavior for internet access according to embodiments.

FIG. 3 is a flowchart of one particular method for configuring rewards in accordance with using reinforcing behavior for Internet access according to embodiments.

FIG. 4 is a flowchart of one particular method for redeeming rewards in accordance with using reinforcing behavior for internet access according to embodiments.

### DESCRIPTION OF THE PREFERRED EMBODIMENT

The present invention is directed to a teaching and reinforcing method for rewarding a person for good behavior. The reward-based system generally discloses an automated process for tracking good behavior, assigning points for such good behavior, and providing a rewards system to enable the person to redeem earned points for in/tangible item(s). In the broadest context, the reward-based system of the present invention consists of components configured and correlated with respect to each other so as to attain the desired objective.

In the present disclosure, certain embodiments are related to tasks and behaviors of for example, students in a classroom, children at home, personnel and persons at various facilities, all of which tracking is recorded by an administrator (e.g. a parent, teacher, officer, etc.) to reward points for good behavior, or the like. Each behavior or activity could be related to specific units or points, and each administrator may have their own grading or points allocated or applied to certain behaviors or activities, depending upon the embodiment. In addition, certain embodiments recognize distinct access points for access to the Internet for tracking behaviors, including desktop computers, laptop computers, tablet computing devices, phones, or other devices which connect to the internet either directly or indirectly.

As used herein, the term “person” designated as numeral 10 for identification purposes, refers to a non-administrative person within the system such as the person (e.g., student) who is attempting to apply good behavior in order to earn points and rewards.

The term “user” designated as numeral 20, refers to an administrative person within the system, such may include the parent, teacher, administrator, supervisor, or other entity who plays a supervising role in a person's learning or behavioral experiences. Other examples of a user may be an employee, a coach, etc.

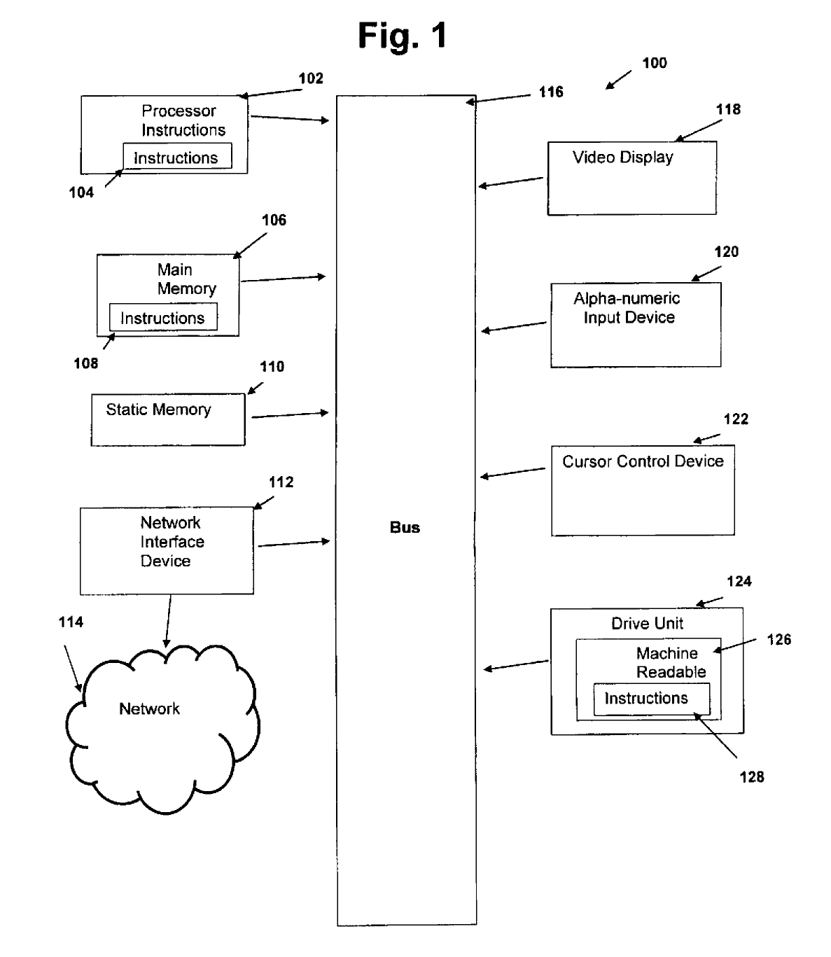

FIG. 1 is a block diagram of an example embodiment of a computer system 100 upon which the embodiment's inventive subject matter can execute. The description of FIG. 1 is intended to provide a brief, general description of suitable computer hardware and a suitable computing environment in conjunction with which the embodiments may be implemented. The embodiments may be described in the general context of computer-executable instructions, such as program modules, being executed by a computer. Generally, program modules include routines, programs, objects, components, data structures, etc., that perform particular tasks for implementing abstract data types.

The system as disclosed herein can be spread across one or many physical hosts. Therefore, many systems and sub-systems of FIG. 1 can be involved in implementing the inventive subject matter disclosed herein.

Moreover, those skilled in the art will appreciate that the embodiments may be practiced with other computer system configurations, including mobile wireless devices, hand-held devices, multiprocessor systems, microprocessor-based or programmable consumer electronics, network PCs, mini computers, mainframe computers, and the like. The embodiments may also be practiced in distributed computer environments where tasks are performed by I/O remote processing devices that are linked through a communications network. In a distributed computing environment, program modules may be located in both local and remote memory storage devices.

The user's 20 wireless device may further be a smartphone or other mobile handheld wireless computerized communications device having standard smartphone functionality, including WiFi transceivers, and may be implemented in the form of a standard smartphone app.

In the embodiment shown in FIG. 1, a hardware and operating environment is provided that is applicable to both servers and/or remote clients.

With reference to FIG. 1, an example embodiment extends to a “machine” in the example form of a computer system 100 within which instructions for causing the machine to perform any one or more methodologies discussed herein may be executed. In alternative example embodiments, the machine operates as a standalone device or may be connected (e.g., networked) to other machines.

In a network deployment, the machine may operate in the capacity of a server or a client machine in server-client network environment, or as a peer machine in a peer-to-peer or distributed network environment. Further, while only a single machine is illustrated, the term “machine” shall also be taken to include any collection of machines that individually or jointly execute a set (or multiple sets) of instructions to perform any one or more of the methodologies discussed herein.

The example computer system 100 may include a processor 102 (e.g., a central processing unit (CPU), a graphics processing unit (GPU) or both) a main memory 106 and a static memory 110, which communicate with each other via a bus 116. The computer system 100 may further include a video display unit 118 (e.g., a liquid crystal display (LCD) or a cathode ray tube (CRT)), one or more of an alpha-numeric input device 120 (e.g., a keyboard), a user interface navigation device or cursor control device 122 (e.g., a mouse, a touchscreen), and a network interface device 112.

The system 100 may further include a disk drive unit 124 that includes a machine-readable medium 126 on which is stored one or more sets of instructions 128 and data structures (e.g., software instructions) embodying or used by any one or more of the methodologies or functions described herein. The instructions 128 may also reside, completely or at least partially within the main memory 108 or within the processor 104 during execution thereof by the computer system 100, the main memory 106 and the processor 102 also constituting machine-readable media.

In some embodiments, the reward-based system of the present invention comprises a client-server architecture where the server portion stands alone or runs on a cloud-computing platform, and clients communicate with servers via networks 114. The reward-based system or the server portion thereof may reside on the cloud-computing platform making its functions readily accessible by other systems that are connected to the cloud-computing platform, which may include the user device, the monitor device, the network provider system, the learning and behavioral system, and the reward system.

As such, it should be understood that the example computing system in the preferred embodiment includes operation of the entire system on a remote server with interactions occurring from individual connections over the network to handle user input as an internet application.

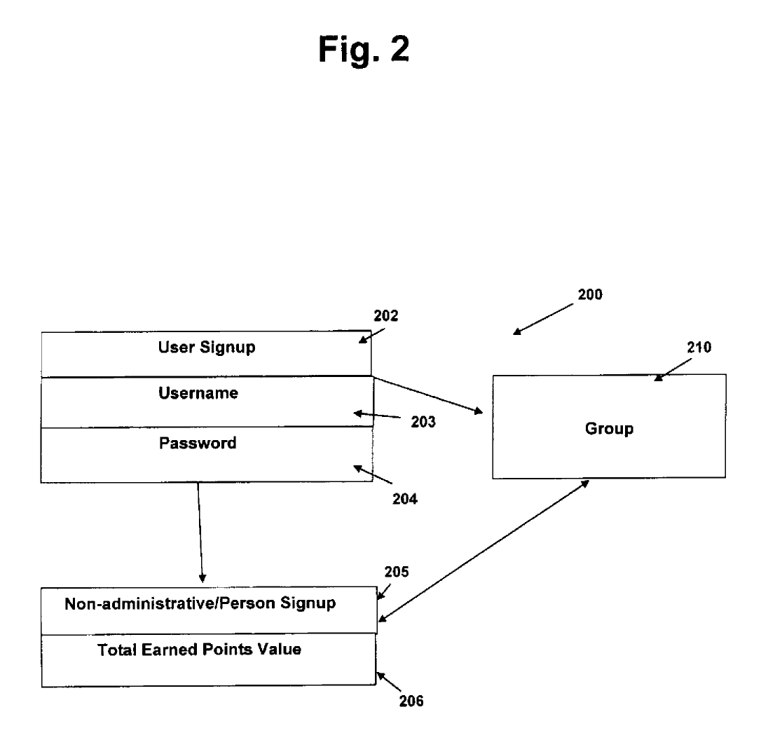

FIG. 2 is a flowchart of the main configuration process 200 of an example embodiment. Configuration initiates with user signup 202 to record each user's 20 identifying information for configuration, including, for example, the user name, and other identifying administrator information.

It should be noted that while the following steps are listed in a specific order, they could appear in alternate orders in alternate embodiments without changing the scope or function of the disclosure. Similarly, the steps can be interspersed or performed in different orders within the same embodiment depending on user choice, or are explained in a particular order only for clarity and simplicity of explanation but without any intended limitation.

Next, a username is entered 203 for the user 20 as an identifier used for tracking the user and associating hardware devices. Each username 203 may have an associated user first name entered and password. To prevent errors, in some embodiments a second prompting for the same password is requested 204 one or more times. This information or similar information in alternate embodiments may be part of the user configuration process. Similarly, the configuration approach is equally viable if the first step is entering a name or a username with other steps occurring in other orders as well. In a school environment, for example, it is anticipated that each user/instructor 20 in that school system will be identified in the system as discussed above, and have their own user identifying information in order to securely access the system.

Configuration further includes the step of non-administrative or person 10 signup 205 to record the identifying information for configuration, including, for example, the person 10 information including name, personal ID number, and other identifying information. In the school application, for example, it is anticipated that each student 10 is added to the system. Signup step 205 further includes initializing each non-administrative person 10 entered into the system with a total earned points value 206 value having a minimum value of zero.

Each person 10 entered in step 205 may also be added to a group 210 which, as will be further discussed, are used to create groups for group rewards and activities. In the school environment for example, a group may identify each student/person 10 assigned to a classroom of students for a particular course of study. In this regard, a group can be identified by the user/teacher 20 in place of a single person/student where a user/teacher elects to reward the entire class (group) for good behavior rather than a single user/student. A non-administrative person 10 added in step 205 may be included in multiple groups in step 210.

It should be understood that the personal ID number entered in step 205 for each person 10 is a unique identifier for the person used for tracking the individual throughout the application process.

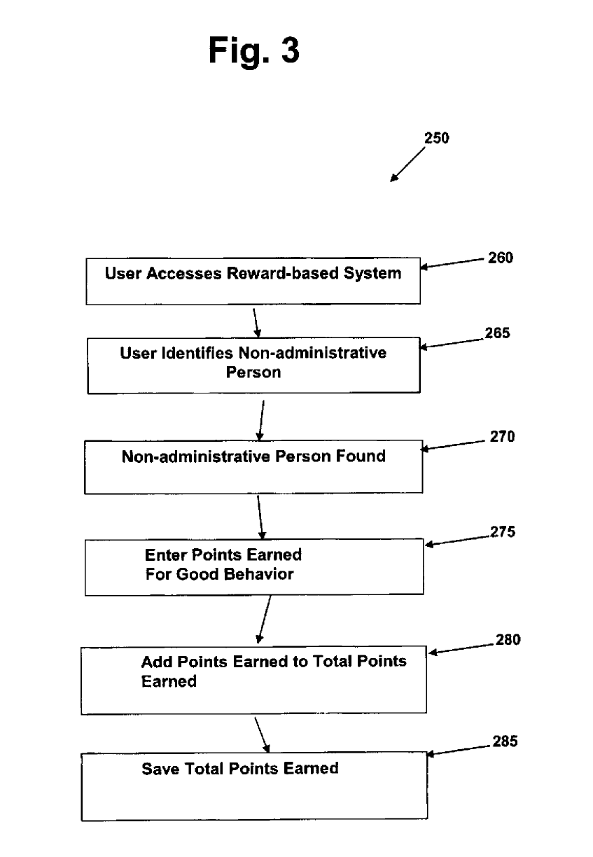

FIG. 3 is a flow chart describing the process of configuring a reward 250. First, when a person 10 has demonstrated good behavior and a user 20 has elected to reward that person for the good behavior, the user 20 first logs into or accesses the reward-based system by entering the user's unique identifier and password (if required) 260 with the user's device. A user device is a user's electronic computing device, such as a smartphone, with web browser or device application capabilities configured to communicate with the reward-based system via the cloud-computing platform or otherwise through networks 114, which comprises any public network such as the Internet or World Wide Web or any public or private network as may be developed in the future. It is the means by which the user 20 participates in the reward-based system.

Once the present system recognizes the user 20, the user selects and enters the value or number of points earned by the person 10 (or group) for the good behavior 265, and then identifies the person 10 to be rewarded by entering the person's unique ID number 270. Entering the unique ID number can be accomplished in any number of ways including, but not limited to, the user 20 entering or typing the ID number into the system, entering the ID number using voice recognition if available, performing a scan process to enter the ID number if available, and again, any number of ways available.

Once the person's 10 ID number has been entered and the system acknowledges recognition 275 that it has found the person in the system, the system accumulates or adds 280 the number of points entered to that person's 10 totaled earned points value. Finally, when all information is correct, the total earned points value is saved in the system 285.

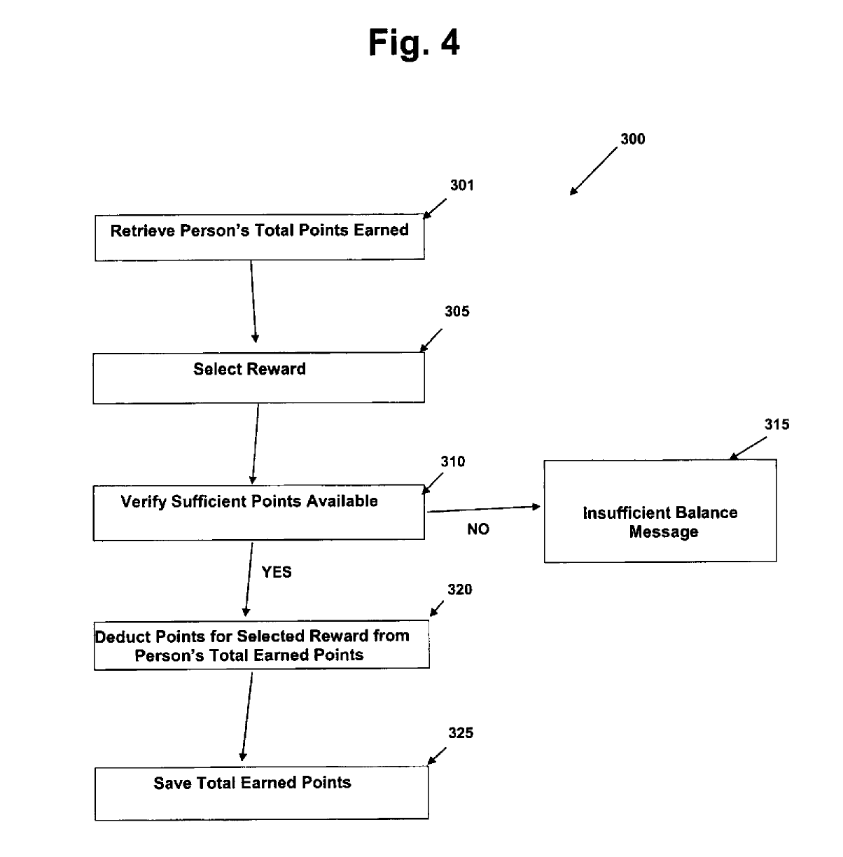

Rewards or earned points are earned over time as virtual currency or points and can be redeemed for a variety of uses. Referring to FIG. 4, in certain embodiments, once the person 10 has accessed the system via the internet, and the system has verified the person's identifying information, the next step for redeeming 300 earned points is to determine 301 the person's 10 total number of points earned that are available for redemption. The system allows access to a person's 10 total earned points value, however again, access to a person's earned points value requires knowing that person's 10 identifying information such as username, password, and/or ID number.

When redeeming, the person 10 has a choice of what type of reward is made from a variety of reward types, such as physical items. Other examples of forms of rewards/redemptions comprise cash, a retailer redemption debit card, and a coupon redeemable online or at a selected retail store.

Each available reward has a cost or value associated, i.e. the total number of points needed to purchase the reward. When a person 10 selects a reward 305, the administrator 20 or system verifies 310 that the person's 10 total number of earned points is sufficient to “pay for” the selected reward. If there is not sufficient balance available in the person's 10 total earned points value to pay for the reward, then the person 10 receives an insufficient balance message 315.

If sufficient balance exists for the chosen reward, then the appropriate redemption process occurs, including deducting 320 the number of points needed to purchase the reward from the person's 10 total earned points value. The person's 10 total earned points value balance, after the purchase is deducted, is then saved in the system 325.

Once the person 10 redeems the reward, the total earned points value for the person is reduced the amount or purchase price of the reward, thereby ensuring that the person's earned points can only be used once.

In the preferred embodiment, the reward component 300 allows a person 10 to accumulate earned rewards and manage the earned rewards. The person 10 can choose to view his/her rewards from a user-interface provided by the reward-based system. When the person 10 chooses a particular reward to redeem, the “cost” of the reward is immediately deducted from the person's total earned points value balance, and the selected reward may be immediately tendered to the person 10 or, the person may then be presented with a corresponding electronic coupon code that may be communicated to a point-of-sale at a retailer's store.

As discussed, groups 210 are used to create an entire group of persons 10, such as, but not limited to, a group of students, peers or employees. Configuration initiates with an administrator 20 identifying a group for configuration, including, for example, the assigned user 20 for that group, and other identifying information relating to the group. Once the group has been identified, the administrator 20 identifies each person 10 that comprises the group. In a school setting, for example, a defined group may be a user/teacher's 20 homeroom, and the persons 10 in the group therefore, will be each student assigned to that user/teacher's homeroom class.

When a class, for example, has demonstrated good behavior and a user 20 has elected to reward the entire class for good behavior, the user 20 first enters or logs into the reward-based system by entering the user's unique identifier and password 260 with the user's device. Next, the user selects and enters the value or number of points that is earned by each person 10 in the group for the good behavior. The user 20 then identifies the group 210 to be rewarded by entering the group's unique ID number. Entering the unique ID number can be accomplished in any number of ways, including the user entering or typing the ID number into the system, or entering the ID number using voice recognition if available.

Once the group's ID number has been entered and the system acknowledges recognition that it has found the group in the system, the system next accumulates or adds the number of points entered to each person 10 in the group's total earned points value. Finally, when all information is correct, the accumulated earned points value for each person 10 in the selected group is saved in the system. It should be understood, the group configuration as disclosed may eliminate the steps of the user having to award each person in a group individually.

Although the above description contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

It would be obvious to those skilled in the art that modifications may be made to the embodiments described above without departing from the scope of the present invention. For example, various additives, modifiers, or selected therapeutic substances may be added to the instant composition with the provision that they are not added in amounts such that the effectiveness of the inventive composition is hindered or to such a degree that the composition becomes unacceptable. Thus the scope of the invention should be determined by the appended claims in the formal application and their legal equivalents, rather than by the examples given.

I claim:

1. A computer implemented method for reinforcing good behavior of a person by awarding such person virtual points and rewards, said method comprising the steps of:
executing an application, said application for web access to a memory;
storing identifying administrator information for a user in said memory, said administrator information including a unique identifier;
storing an account of a person in the memory, said account including said person's personal ID number and a total points earned value;
receiving a request at a processor to reward said person for good behavior comprising the steps of:
entering the user's unique identifier,
verifying said user's unique identifier entered,
assigning a point value earned by said person for good behavior,
entering the person's personal ID number,
verifying said person's personal ID number entered,
increasing said person's total points earned value by said point value,
storing said person's increased total points earned value in said memory;
receiving a request from said person to redeem said person's total points earned value for a reward.

2. The computer implemented method of claim 1, wherein the step of redeeming said person's total points earned value comprising the steps of:
entering the person's personal ID number,
verifying said person's personal ID number entered,
determining the person's total number of points earned,
selecting the reward, said reward having a value,
verifying the person's total number of earned points is greater than or equal to the selected reward's value, and wherein if said selected reward's value is greater than said person's total points earned value then denying the redeeming step,
decreasing said person's total points earned value by said selected reward's value,
storing said person's decreased total earned points value in said memory.

3. The computer implemented method of claim 1, wherein said user initiates said application on an electronic device.

4. The computer implemented method of claim 3, wherein said electronic device is a wireless communications device.

5. The computer implemented method of claim 4, wherein said electronic device is a smartphone.

6. The computer implemented method of claim 5, wherein said smartphone configured for web access with said processor.

7. The method as recited in claim 6, wherein said entering the person's personal ID step includes said user scanning the person's personal ID from said smartphone.

8. The computer implemented method of claim 1, wherein said person's personal ID number represents a group having a plurality of persons.

9. The computer implemented method of claim 8, wherein the step of increasing said person's total points earned value by said point value includes increasing each of said plurality of persons in said group's total points earned value by said point value.

10. A computer implemented system for reinforcing good behavior of a person by awarding such person virtual points and rewards, said system comprising:
a computer network;
an administrator file accessible to an electronic device, said administrator file including identifying information for a plurality of users, said identifying information including a unique identifier for each of said plurality of users, and wherein said administrator file is stored in a memory on said computer network;
a person file accessible to said electronic device, said person file including an account for a plurality of persons, said account including a personal ID number and an earned points for each of said plurality of persons, wherein said person file is stored in said memory;
said computer network system configured for receiving a request from each of said plurality of users to reward at least one person of said plurality of persons for good behavior;
a first user interface enabling a single user of said plurality of users to enter said single user's unique identifier;
a user verification module configured for verifying said single user's unique identifier entered;
a second user interface enabling said single user to enter a point value earned for said good behavior;
a third user interface enabling said single user to enter a selected person's of said plurality of persons personal ID;
a person verification module configured for verifying said selected person's personal ID entered;
a points management module configured for increasing said selected person's earned points by said point value and storing said selected person's increased earned points in said memory; and
a fourth user interface providing a redeeming function of redeeming each of said plurality of persons earned points.

11. The system as recited in claim 10, wherein said fourth user interface further enabling a redeeming person of said plurality of persons access to said redeeming person's earned points.

12. The system as recited in claim 11, wherein said redeeming function includes verifying that said redeeming person's earned points are greater than said reward's value.

13. The system as recited in claim 12, wherein said computer network is a cloud system.

14. The system as recited in claim 13, wherein said electronic device is configured to communicate with the computer network via a public network.

15. The system as recited in claim 14, wherein said public network is the Internet.

16. The system as recited in claim 15, wherein said electronic device is a wireless communication device.

17. The system as recited in claim 16, wherein said electronic device is a smartphone.

18. The system as recited in claim 17, wherein said smartphone is configured for scanning said selected person's personal ID on said third user interface.

19. The system as recited in claim 10, wherein at least one of said personal IDs in said account represents a group of persons.

20. The system as recited in claim 19, wherein said points management module further includes increasing each person's in said group of persons earned points by said point value.
